(19) United States
(12) Patent Application Publication
(10) Pub. No.: US 2008/0160895 A1
(43) Pub. Date: Jul. 3, 2008

(54) Atmosphere control apparatus, device-manufacturing apparatus, device-manufacturing method, and exposure apparatus

(75) Inventor: Yoshitomo NAGAHASHI, Takasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/073,251

(22) Filed: Mar. 3, 2008

Related U.S. Application Data
(62) Division of application No. 11/407,127, filed on Apr. 20, 2006.
Application No. 11/407,127 is a continuation of application No. PCT/JP2004/015618, filed on Oct. 21, 2004.

(30) Foreign Application Priority Data
Oct. 21, 2003 (JP) 2003-360681
Feb. 10, 2004 (JP) 2004-033677

(51) Int. Cl. B08B 15/00

(52) U.S. Cl. 454/66

(57) ABSTRACT

An atmosphere control apparatus includes an air introducing mechanism which introduces air from an air introducing port, and a first impurity removing mechanism which removes impurities from the air. The air introducing mechanism is disposed between the air introducing port and the first impurity removing mechanism. By doing this, it is made possible to provide an atmosphere control apparatus which can prevent external atmosphere from entering a chamber containing a device-manufacturing apparatus so that the atmosphere in the chamber can be controlled accurately.

### CROSS-REFERENCE TO RELATED APPLICATION

This is a Divisional application of application Ser. No. 11/407,127, filed Apr. 20, 2006, which in turn is a Continuation of International Application No. PCT/JP2004/015618, filed Oct. 21, 2004, which claims priority to Japanese Patent Application Nos. 2003-360681 (filed on Oct. 21, 2003) and 2004-033677 (filed on Feb. 10, 2004). The contents of the aforementioned applications are incorporated herein by reference in their entireties.

### BACKGROUND OF THE INVENTION

1. Field of the Invention

The present invention relates to an atmosphere control apparatus having a chamber which encloses at least a part of a device-manufacturing apparatus.

Also, the present invention relates to an exposure apparatus which has an exposure main body section having a projection optical system which transfers mask patterns onto substrates; and a chamber which encloses at least a part of the exposure main body section.

2. Description of Related Art

Conventionally, exposure apparatuses transferring circuit patterns formed on masks (or reticles) onto photo-resist-coated substrates (e.g., wafers and glass plates) have been used in processes for manufacturing electronic devices, e.g., semiconductor elements and liquid display elements.

In recent years, exposure apparatuses have been using exposure light beams having shorter wavelengths because finer micro-patterning has been required. For example, there is a tendency toward use of light sources emitting light beams having shorter wavelengths, e.g., KrF excimer lasers having a wavelength of 248 nm, and ArF excimer lasers having a wavelength of 193 nm instead of the formerly and still commonly used mercury lamps. Controlling the atmosphere, e.g. density of impurities, temperature, and humidity, in spaces containing optical axes and the exposure apparatuses containing the optical axes is required in such exposure apparatuses using exposure light beams having shorter wavelengths.

With respect to manufacturing of electronic devices, it is necessary to control the atmosphere not only in exposure apparatuses but also other device-manufacturing apparatuses, e.g., a coater/developer which applies photo-resists onto substrates and develops the resist-coated substrates.

With respect to technology for controlling atmosphere, Japanese Unexamined Patent Application, First Publications No. 2002-158170 discloses an example in which air (external atmosphere) is introduced through an air introducing port into a chamber containing a device-manufacturing apparatus; impurities are removed from the introduced air; temperature and humidity of the air are regulated; and the temperature-and-humidity-controlled air is circulated in the chamber. According to this technology, external atmosphere is prevented from entering the chamber because the regulated air circulates in the chamber; the chamber is filled with the circulating air; and the circulating air has higher pressure than the pressure of external atmosphere.

However, sizes of device-manufacturing apparatuses have become larger because sizes of substrates have become larger in device-manufacturing processes in recent years; therefore, sizes of clean rooms have become larger accordingly. It is common for such clean rooms to have separate areas, e.g., an operation area in which cleanliness is strictly controlled, and a maintenance area in which the cleanliness control is relatively moderate. In such a case, a chamber containing a part of the device-manufacturing apparatus, e.g., an operation-side of the device-manufacturing apparatus, is disposed in the strictly-controlled area. The rest of the part of the apparatus is disposed in the relatively-moderately-controlled area.

With respect to quality control in the case of separate dispositions within the clean room, pressure in the strictly-controlled area tends to be relatively higher; thus, pressure is different between the separated areas by, e.g., 1 to 10 Pa. Such pressure difference is likely to cause external atmosphere enter the chamber because air flows from the high-pressure area to the low-pressure area through the chamber containing the device-manufacturing apparatus. If external atmosphere, e.g.: non-temperature-and-humidity-controlled air; and air containing impurities flow into the chamber, the atmosphere in the chamber is made worse; thus, quality of the manufactured devices will be lower.

Also, circulated air is commonly used in technology for controlling the atmosphere in the chamber. That is, air introduced into the chamber is circulated to pass through impurity removing devices and a temperature/humidity-regulating device.

Fans used for air circulation are likely to generate a large pressure difference between the downstream and upstream sides of the fan. That is, pressure is high downstream in the circulation path from the fan, and pressure is tremendously low upstream. However, if the pressure decreases in the circulation path greatly, external atmosphere may enter the circulation path, not from the air introducing ports of the chamber, but from, e.g., vacant holes; therefore, the atmosphere in the chamber may be made worse by such external ambient.

Also, air pressure decreases near exhaust ports of the chamber because a fan attracts the air circulating in the chamber. Therefore, air pressure is low in parts of in the chamber with respect to external atmosphere; thus, the external atmosphere may enter the chamber similarly to the above explained conditions.

Apertures formed in the chamber are used in maintenance of the exposure main body section disposed in the chamber; therefore, external atmosphere thereof may flow into a space in the chamber through such apertures for maintenance. If non-regulated air, e.g., non-temperature-regulated air and air containing impurities enters the chamber, the atmosphere in the chamber may be made worse. In particular, if external atmosphere enters spaces in which important processes are conducted, exposure accuracy may degrade and it will take long time to remove the atmosphere.

### SUMMARY OF THE INVENTION

The present invention was conceived in view of the above circumstances, and an object thereof is to provide an atmosphere control apparatus which prevents external atmosphere from entering a chamber; and enables controlling of the atmosphere in the chamber with high accuracy.

Another object thereof is to provide a device-manufacturing apparatus and a device-manufacturing method, so that high quality devices can be produced.

In addition, another object thereof is to provide an exposure apparatus which prevents external atmosphere from entering a chamber containing a main exposure section and conducts exposure processes stably.

In order to achieve the above objects, the present invention employs the following features corresponding to embodiments shown in FIGS. 1 to 3.

An atmosphere control apparatus according to a first aspect of the present invention includes an air-introducing mechanism having an air introducing port which introduces air, the air introducing mechanism being disposed between the air introducing port and a first impurity removing mechanism which removes impurities from the introduced air.

Air is introduced from the air introducing port into the atmosphere control apparatus. The introduced air, having pressure increased by the air introducing mechanism, is supplied to the chamber through the first impurity removing mechanism. Thus, it is possible to prevent external atmosphere from entering the chamber because air pressure is high downstream from the air introducing mechanism. Also, it is possible to prevent air eluding the first impurity removing mechanism from flowing into the chamber because the first impurity removing mechanism is disposed downstream from the air introducing mechanism, which prevents air from entering the chamber. Therefore, impurities contained in the air supplied into the chamber can be removed by the first impurity removing mechanism reliably. Therefore, this atmosphere control apparatus can prevent external atmosphere from entering the chamber reliably.

Also, the above explained atmosphere control apparatus according to the first aspect of the present invention further includes a temperature regulating mechanism which regulates the temperature of the introduced air, the temperature regulating mechanism being disposed between the air introducing mechanism and the air introducing port. Therefore, temperature-regulated air is supplied into the chamber. This structure is free of air-flow drag due to the temperature regulating mechanism because the air introducing mechanism is disposed upstream from the temperature regulating mechanism instead of downstream. Therefore, air pressure can be increased reliably downstream from the air introducing mechanism.

Also, the atmosphere control apparatus according to the first aspect of the present invention may further includes an air conditioning unit having the air introducing port which encloses at least one of the air introducing mechanism and the temperature regulating mechanism the air conditioning unit being disposed separately from external atmosphere in which a chamber is disposed; the chamber enclosing at least a part of a device-manufacturing apparatus and a duct which connects the air conditioning unit and the chamber. By doing this, space for enclosing the chamber can be reduced; thus, it is possible to reduce facility costs.

In this case, the chamber may be designed to have an aperture which connects to the duct; and a second impurity removing mechanism disposed at the aperture. By doing this, it is possible to prevent external atmosphere from entering the chamber through the duct.

Also, the air introducing mechanism, free of impurity removing filters which remove impurities from the introduced air, may take the air from the air introducing port in the atmosphere control apparatus according to the first aspect of the present invention. Therefore, load applied to the air introducing mechanism can be mitigated.

Also, the chamber may have air exhaust ports which exhaust the air introduced through the first impurity removing mechanism and the second impurity removing mechanism to therefrom in the atmosphere control apparatus according to the first aspect of the present invention. In this case, impurities contained in the air but not removed by the first and the second impurity removing mechanisms can be exhausted from the air exhaust ports.

Also, the chamber may have a local circulating system which sends the air introduced through the first impurity removing mechanism and the second impurity removing mechanism to at least a predetermined local space in the device-manufacturing apparatus; and circulates the air in the local space in the atmosphere control apparatus according to the first aspect of the present invention. In this case, it is possible to increase air pressure in the local space in the chamber reliably using the local circulating system.

An atmosphere control apparatus according to a second aspect of the present invention includes a chamber which encloses at least a part of a device-manufacturing apparatus; an air introducing mechanism which introduces air and sends the introduced air into the chamber; air exhaust ports which exhaust the air introduced into the chamber by the air introducing mechanism therefrom; and exhaust regulating mechanisms which regulate a quantity of the air exhausted from the chamber.

In the present atmosphere control apparatus, air introduced by the air introducing mechanism into the chamber is exhausted to therefrom directly through the air exhaust port. That is, air in the chamber will never be attracted by, e.g., the air introducing mechanism. Therefore, air pressure in the overall chamber including the air supplied thereto increases; thus, it is possible to prevent external atmosphere from entering the chamber. Also, air pressure in the chamber can be regulated reliably because the air regulating mechanisms regulate displacement, i.e., quantity of air exhausted from the chamber. It is possible to increase air pressure in the chamber reliably by, e.g., decreasing the displacement by the air regulating mechanisms.

The air regulating mechanisms may regulate the size of the apertures disposed at the air exhaust ports in the above atmosphere control apparatus according to the second aspect of the present invention. In this case, displacement from the chamber is regulated in accordance with the size of the apertures disposed at the air exhaust ports.

Also, the air exhaust ports may be disposed to be faced air ventilation ports disposed on the chamber, across at least of the device-manufacturing apparatus. By doing this, it is possible to increase air pressure in areas in which at least a part of the device-manufacturing apparatus is disposed reliably.

Also, the atmosphere control apparatus according to the second aspect may be designed to further include a separating member which isolates a part of space in the chamber enclosing at least a part of the device-manufacturing apparatus and the rest of space in the chamber. In this case, it is possible to regulate air-flow in the chamber using the separating member; therefore, it is possible to increase air pressure in areas in which at least a part of the device-manufacturing apparatus is disposed reliably.

Also, the atmosphere control apparatus according to the second aspect may further include a temperature regulating mechanism which regulates the temperature of air; and an impurity removing mechanism, disposed downstream from the temperature regulating mechanism, which removes impurities contained in the air, the air introducing mechanism being disposed between the temperature regulating mechanism and the impurity removing mechanism. This structure is free from air-flow drag due to the temperature regulating mechanism because the air introducing mechanism is disposed upstream from the temperature regulating mechanism instead of downstream. Therefore, air pressure can be increased reliably downstream from the air introducing mechanism.

Also, the atmosphere control apparatus according to the second aspect may further include an air conditioning unit which encloses at least one of the temperature regulating mechanism and the air introducing mechanism, the air conditioning unit being disposed separately from external atmosphere in which a chamber is disposed; the chamber enclosing at least a part of a device-manufacturing apparatus; and a duct which connects the air conditioning unit and the chamber. By doing this, space including the chamber can be reduced; thus, it is possible to reduce facility costs.

Also, the chamber has a local circulating system which sends the air from the chamber to a local space of the device-manufacturing apparatus, including a predetermined part of the device-manufacturing apparatus; and circulates the air in the local space in the atmosphere control apparatus according to the second aspect of the present invention.

In this case, the local circulating system may have at least one of the temperature regulating mechanism which regulates the temperature of introduced air; the air introducing mechanism, disposed downstream from the temperature regulating mechanism, which introduces the air from the chamber; and the impurity removing mechanism, disposed in downstream from the air introducing mechanism, which removes impurities contained in the introduced air. The local circulating system has the temperature regulating mechanism; thus, it is possible to regulate the temperature of air in the chamber very accurately. Also, the local circulating system has the air introducing mechanism; therefore, it is possible to increase pressure of air in the local space more reliably. Also, the local circulating system has the impurity removing mechanism; therefore, it is possible to increase cleanliness in the local space.

An atmosphere control device according to third aspect of the present invention includes a chamber which encloses at least a part of a device-manufacturing apparatus an air introducing mechanism which introduces air and sends the introduced air into the chamber; air exhaust ports which exhausts the introduced air from the chamber; and a local circulating system which sends the air from the chamber to a local space of the device-manufacturing apparatus, including a predetermined part of the device-manufacturing apparatus; and circulates the air in the local space.

Air introduced by the air introducing mechanism is supplied to the chamber in this atmosphere control device. The supplied air is exhausted directly through the air exhaust ports. In this case, air is not attracted from the chamber by the air introducing mechanism. Therefore, the air supplied to the chamber increases air pressure in the overall chamber; thus, it is possible to prevent external atmosphere from entering the chamber. Also, it is possible to increase air pressure in the local space in the chamber reliably because the atmosphere control apparatus has the local circulating system. external atmosphere is prevented from entering the local space more reliably due to increase of the air pressure in the local space.

In this case, the local circulating system may have at least one of the temperature regulating mechanism which regulates temperature of the introduced air; the air introducing mechanism, disposed downstream from the temperature regulating mechanism, which introduces the air from the chamber; and the impurity removing mechanism, disposed downstream from the air introducing mechanism, which removes impurity contained in the introduced air. The local circulating system has the temperature regulating mechanism; thus, it is possible to regulate temperature of air in the local space in the chamber very accurately. Also, the local circulating system has the air introducing mechanism; therefore, it is possible to increase air pressure in the local space more reliably. Also, the local circulating system has the impurity removing mechanism; therefore, it is possible to increase the purity (of air) in the local space.

Also, the device-manufacturing apparatus may be an exposure apparatus which transfers patterns formed on masks onto photosensitive substrates in the above atmosphere control apparatus according to the first to third aspects of the present invention.

In this case, it is possible to improve exposure accuracy by improving the ability to control the atmosphere.

Also, the device-manufacturing apparatus may be, e.g., a coater/developer which applies photo-resists on substrates and develops the resist-coated substrates. In this case, it is possible to improve capabilities with respect to resist-coating and coating-development by improving the ability of control the atmosphere.

Also, the device-manufacturing apparatus according to the present invention has the atmosphere control apparatus according to one of the first to third aspects.

Also, the device-manufacturing method according to the present invention uses the atmosphere control apparatus according to one of the first to third aspects to produce devices.

An exposure apparatus of the present invention includes an exposure main body section having an exposure optical system which transfers mask patterns onto substrates; and a chamber which encloses at least a part of the exposure main body section, wherein the chamber has separating members which separate a first space and second spaces, the first space enclosing a first one of a plurality of elements which form at least a part of the exposure main body section, the second spaces enclosing a second one of the elements; and the separating members preventing external atmosphere around the chamber from entering the first space during maintenance of the second one of the elements disposed in the second spaces through apertures formed in the chamber.

The separating members prevent external atmosphere from entering a space, e.g., the first space including predetermined elements during maintenance of elements different from the predetermined elements in the chamber in the exposure apparatus. That is, if external atmosphere flows into the chamber during maintenance, the air-flow is limited to a part of space (second spaces) in the chamber. Therefore, it is possible to prevent external atmosphere from flowing into spaces in which important processes are conducted; and shorten the time needed to remove external atmosphere which has flown into the spaces.

The first one of the elements disposed in the first space may be subjected to maintenance using apertures formed in the chamber; and the separating member in the above exposure apparatus.

In this case, the overall apparatus can be simple because the first one of the elements and the second one of the elements are subject to maintenance using the same apertures.

Also, in the above exposure apparatus, the second one of the elements is subject to maintenance more frequently than the first one of the elements. Therefore, external atmosphere is prevented from entering a space containing the elements to be subject to maintenance more frequently.

Also, in the above exposure apparatus, the second one of the elements includes at least, e.g., one of a temperature regulating mechanism which regulates the temperature of the exposure main body section; and an electric control section which controls the exposure main body section electrically. Generally, these control sections are subject to maintenance frequently.

Also, in the above exposure apparatus, the separating members are disposed so as to be capable of freely opening and closing in the chamber. Therefore, maintenance can be conducted more easily.

Also, in the above exposure apparatus, the separating members may be formed from chemically-cleansed sheet members.

Operability can be improved because the separating members are sheet members. Also, it is possible to prevent impurities from being produced from the separating members because the separating members may be formed from chemically-cleansed sheet members.

Also, in the above exposure apparatus, the first one of the elements includes, e.g., a transportation mechanism which transports the substrates.

In this case, external atmosphere is prevented from entering the space which must be strictly kept clean because the substrates are disposed therein.

Also, the above exposure apparatus may be designed to further include atmosphere control apparatuses which regulate the atmosphere in the first space so that air pressure in the first space is higher than air pressure in the second space at least during maintenance of the second one of the elements.

By doing this, external atmosphere is prevented from entering the first space more reliably because air flows from the first space having higher pressure to the second space during maintenance of the second one of the elements.

In accordance with the exposure apparatus of the present invention, exposure can be conducted stably because the external atmosphere is prevented from entering the chamber by the separating members during maintenance.

In accordance with the atmosphere control apparatus, it is possible to regulate the atmosphere in the chamber very accurately because external atmosphere is prevented from entering the chamber.

Also, in accordance with the device-manufacturing apparatus and the device-manufacturing method of the present invention, it is possible to improve the quality of devices because the devices are manufactured in the highly-accurately-regulated atmosphere.

### BRIEF DESCRIPTION OF THE DRAWINGS

FIG. 1 is a view schematically showing an example of embodiments with respect to an atmosphere control apparatus (exposure apparatus) of the present invention.

FIG. 2 is a view schematically showing a structure of the exposure apparatus.

FIG. 3 is a view showing an air exhaust port formed on a main body chamber.

FIG. 4 is a flow chart showing a device-manufacturing method.

FIG. 5 is a flow chart showing a method for manufacturing semiconductor elements.

FIG. 6 is a view showing dispositions of regulating sections.

FIG. 7 is a plan view showing the disposition of a separating member.

### DETAILED DESCRIPTION OF THE INVENTION

Next, embodiments of the present invention will be explained with reference to the drawings.

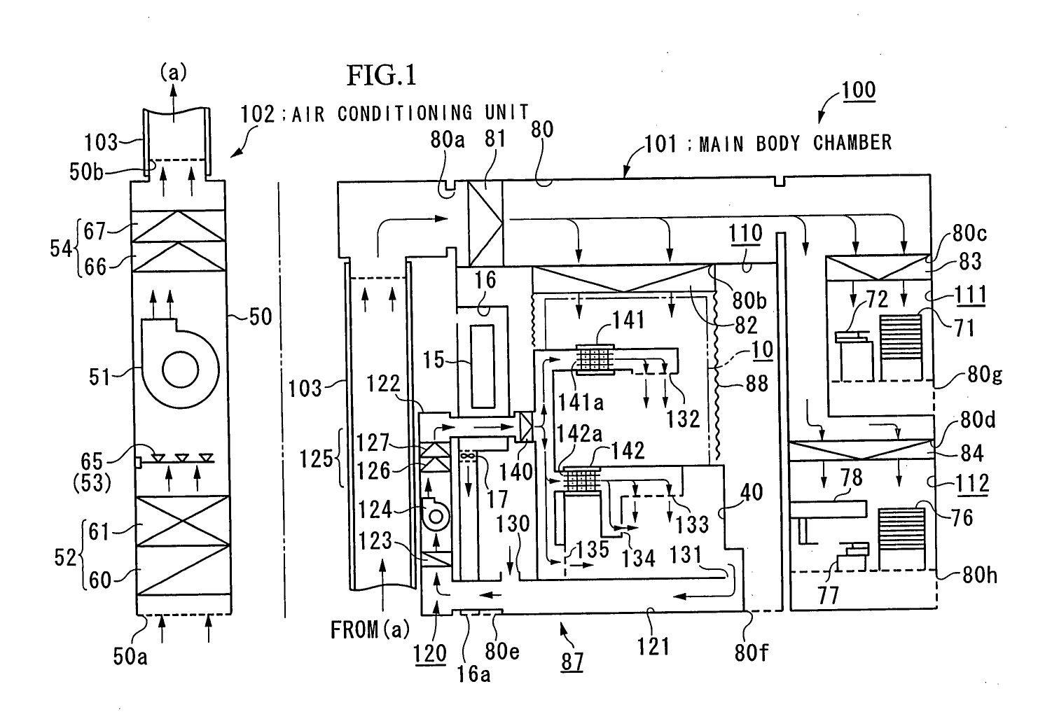

FIG. 1 shows an example of embodiments with respect to an atmosphere control apparatus of the present invention. An atmosphere control apparatus 100, used in an exposure apparatus 10 disposed in a clean room, i.e., an external atmosphere, essentially includes: a main body chamber 101 containing the exposure apparatus 10; and an air conditioning unit 102 supplying temperature-and-humidity-controlled air into the main body chamber 101.

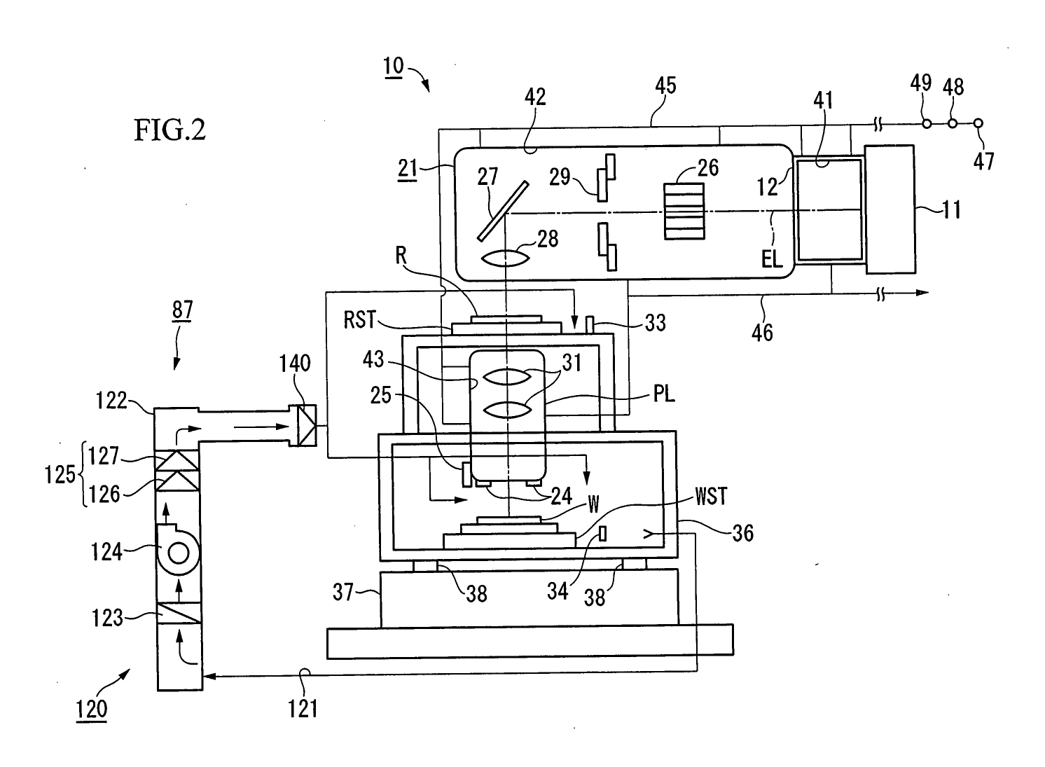

Also, FIG. 2 shows the structure of the exposure apparatus 10 schematically. In the present embodiment, the exposure apparatus 10 uses a step-and-scan method in which a reticle R and a wafer W are scanned with respect to an illuminated area on the reticle having a predetermined shape, e.g., a mask (projection master); and pattern images corresponding to the reticle R onto a shot area on the wafer W sequentially.

To begin with, a structure of the exposure apparatus 10 is explained with reference to FIG. 2.

The exposure apparatus 10 includes, e.g., a laser light source 11 emitting ArF excimer laser light (λ=193 nm); an illuminating system 21 lighting the reticle R disposed in line with an exposure light beam EL; a reticle stage RST carrying the reticle R thereon; a projection light optical system PL emitting the exposure light beam EL emitted from the reticle R onto a wafer W; a wafer stage WST carrying the wafer W thereon; and a control apparatus 15 (see FIG. 1) controlling overall apparatus integrally.

The exposure light beam EL is introduced into the illuminating system 21 from the exposure light source 11 through a beam-matching-unit (hereinafter referred to as “BMU”). The BMU 12, which includes a plurality of optical elements, connects the exposure light source 11 and the illuminating system 21 optically. The exposure light source 11 is disposed, e.g. under a floor of a utility room or in a utility room disposed adjacent to the clean room.

The illuminating system 21 includes optical elements, e.g.: a fry eye lens (a rod integrator is also acceptable) 26 functioning as the optical integrator; a mirror 27; and a condenser lens 28. The exposure light beam EL emitted from the exposure light source 11 is introduced into the illuminating system 21 through the BMU 12. The fry eye lens 26 forms a plurality of secondary light sources which emit light having uniform illumination distribution onto the reticle R disposed rearward with respect to the fry eye lens 26. A reticle blind 29 which regularize the exposure light beam EL in shape is disposed rearward with respect to the fry eye lens 26.

Parallel glass plates (not shown in the drawing) are disposed at both the entrance and the exit of the illuminating system 21, through which the exposure light beam passes. The parallel glass plates are formed of, substance transmissive with respect to the exposure light beam EL, e.g., synthesized quartz or fluorite.

The projection optical system PL includes a pair of cover glasses (not shown in the drawings) disposed at an entrance section and an exit section through which the exposure light beam EL passes, and a plurality of lens element (only two elements are shown in FIG. 2) disposed between the pair of the cover glasses. Also, the projection optical system PL forms scaled-down projection images, e.g., ⅕ scale images or ¼ scale images of circuit patterns formed on the reticle R on the wafer which has a photo-resist coating thereon, the coating being sensitive with respect to the exposure light beam EL.

The reticle stage RST holds the reticle R, which has a predetermined pattern thereon, so that the reticle R is freely movable with respect to a plane orthogonal to an optical axis of the exposure light beam EL. A moving mirror (not shown in the drawing), which reflects a laser beam emitted by a reticle-side interferometer 33, is fixed to an end of the reticle stage RST corresponding to the reticle-side interferometer 33.

The position of the reticle stage RST with respect to the scanning direction is continuously measured by the reticle-side interferometer so that the reticle stage RST is controlled, i.e., driven in a predetermined scanning direction by a control device 15 (see FIG. 1) which controls overall operation of the exposure apparatus 10.

The wafer stage WST holds the wafer W having a photo-resist coating thereon, the coating being sensitive with respect to the exposure light beam EL so that the wafer W is freely movable in a plane orthogonal with respect to the optical axis of the exposure light beam EL, and also along the optical axis.

A moving mirror (not shown in the drawing), which reflects the laser beam emitted by the wafer-side interferometer 34, is fixed to an end of the wafer stage WST corresponding to the wafer-side interferometer 34 so that the position of a wafer with respect to the moving wafer stage WST is measured by the wafer-side interferometer 34 continuously. In addition, the wafer stage WST is movably controlled by the above control apparatus 15 (see FIG. 1) with respect to not only the above scanning direction but also a direction orthogonal to the scanning direction. By doing this, step-and-scan movement can be conducted in which each shot area on the wafer W is scanned and exposed repeatedly.

The wafer stage WST is disposed in a supporting member, e.g., a main body column 36. In addition to the above wafer stage WST, auto-focus sensors 24 using an oblique incident illumination method and an alignment sensor 25 using an off-axis method are disposed in the main body column 36 so that the position of the wafer W with respect to the Z direction (focusing position) and inclination angle of the wafer W can be measured. Elements composing the exposure apparatus 10, e.g. the reticle stage RST, the projection optical system PL, and the wafer stage WST are held by the main body column 36 supported by a plurality of anti-vibration bases 38 disposed on a base plate 37.

Illuminated areas of the reticle R are controlled to make them into rectangles (slits) by the reticle blind 29 when the above exposure apparatus using the step-and-scan method scans and exposes circuit patterns onto shot areas on the wafer W. Such an illuminated area has a longitudinal direction orthogonal with respect to scanning the reticle R. An exposure light beam having circuit patterns formed on the reticle R is scanned at a predetermined velocity Vr from an end of the slit-shaped illuminated areas to the other end thereof sequentially. In this function, circuit patterns formed in the illuminated areas on the reticle R are projected onto the wafer W by the projection optical system PL; thus, projection areas are formed.

In this case, the wafer W has an inverted image of the reticle R; therefore, the wafer W is scanned at a predetermined velocity Vw synchronously in a reverse direction with respect to scanning of the reticle R. By doing this, an overall surface of the shot areas on the wafer W can be exposed. With respect to the scanning velocity, a ratio Vw/Vr corresponds to a reduction rate of the projection optical system so that accurately scaled circuit patterns formed on the reticle R can be transferred onto each shot area on the wafer W.

Elements in the air, e.g., oxygen and carbon dioxide tend to absorb energy of the ArF laser beam used in the exposure apparatus 10. Therefore, optical paths, e.g., an illumination path disposed between the exposure light source 11 and the reticle R, and a projection path disposed between the reticle R and the wafer W, in the exposure apparatus 10 are isolated from external atmosphere by supplying gas less absorptive with respect to ArF laser beams.

More specifically, the optical paths in the BMU 12, the illuminating system 21, and the projection optical system PL, are isolated from external atmosphere by casings 41, 42, and 43. A supply pipe 45 and an exhaust pipe 46 are connected to each casing 41, 42, and 43 so that optically-inert purge gas can be supplied from a tank 47 disposed in a utility plant in a micro-device factory. Also, the gas is exhausted from each casing 41, 42, and 43 to outside of the factory through the exhaust pipe 46.

The inert gas is a single element or mixed gas selected from nitrogen, helium, neon, argon, krypton, xenon, and radon. The inert gas is chemically refined. The purge gas is supplied into the casings 41, 42, and 43 to reduce the density of impurities, e.g. oxygen which contaminates the optical elements, and organic compounds. Organic compounds accumulate and tarnish the surface of the optical elements when the exposure light beam EL is emitted. Oxygen absorbs the ArF laser beam. Among such organic compounds, e.g., an organic silicon compound, ammonium salt, surfate, a volatile compound evaporated from photo-resist coated on the wafer W, a volatile compound evaporated from an anti-friction agent used in elements forming the various driving sections, and a volatile compound evaporated from a coating layer of wirings used to supply electricity and signals to electric parts can be mentioned.

Impurities such as organic compounds and oxygen may be contained in the purge gas. Therefore, a purge gas filter 48 which removes impurities in the purge gas and a temperature-conditioning-dryer 49 which regulates temperature of the purge gas and removes humidity in the purge gas are disposed in the middle of the supply pipe 45.

Returning to FIG. 1, the main body chamber 101 and air conditioning unit 102, constitute the atmosphere control apparatus 100, are explained.

In the present embodiment, the main body chamber 101 is disposed on a floor of a clean room. The air conditioning unit 102 is disposed in a utility room, which is under a clean room; or in a utility room disposed adjacent to the clean room. The main body chamber 101 and the air conditioning unit 102 are connected by a duct 103.

The atmosphere, e.g., temperature and density of impurities in the clean room, is accurately controlled. In contrast, it is not necessary to control atmosphere in the utility room as much as the clean room. In the present embodiment, the air conditioning unit 102 is disposed in the utility room in order to save space used for exposure processes in the clean room and reduce management cost. The duct 103 is made of a relatively non-contaminative material, e.g., aluminum, stainless steel (SUS), or fluorine resin, so that the optical performance of the optical elements is not made worse because the material produces less impurities adhesive to surface of the optical elements. In the present embodiment, the duct 103 has superior thermal insulation because it is formed of aluminum dual pipe having an inner pipe, an outer pipe, and a thermal insulator (e.g., a foamed material) disposed between the inner pipe and the outer pipe.

The air conditioning unit 102, formed of, e.g., a casing 50, and a fan 51 disposed in the casing 50, introduces air from outside, regulates the temperature of introduced air to keep it at a predetermined temperature, removes impurities from the air, and supplies the air to the main body chamber 101.

An air introducing port 50a for introducing air from outside and an air exhaust port 50b for exhausting the introduced air are formed on the air conditioning unit 102. The air exhaust port 50b is connected to the above duct 103. In addition, a temperature control mechanism 52 and a humidity control mechanism 53 are disposed between the air introducing port 50a and the fan 51. A first impurity removing mechanism 54 is disposed between the fan 51 and the air exhaust port 50b.

The temperature control mechanism 52, having a cooler 60 which refrigerates air upstream thereof and a heater 61 which heats air downstream thereof, regulates the air introduced into the casing 50 through the air introducing port 50a. The temperature control mechanism 52 has a temperature sensor (not shown in the drawing) which measures the temperature of air so that the cooler 60 and the heater 61 can be controlled by the control apparatus 15 in accordance with the measurement results of the temperature sensor. More specifically, the control apparatus 15 controls the cooler 60 and the heater 61 in accordance with the measurement results of the temperature sensor so that the temperature of supplied air to the main body chamber 101 is constant (e.g., 23° C.) in a range of, e.g., 20 to 30° C.

The humidity control mechanism 53, which has a humidifier 65 and humidity sensor (not shown in the drawing), regulates humidity of the air having the temperature regulated by the temperature control mechanism 52. The humidity sensor used in the present embodiment is of the relative-humidity-detecting type. More specifically, impedance-capacity-variant humidity sensors, electromagnetic-wave-absorptive humidity sensors, thermal-conductance-adaptive humidity sensors, and quartz-oscillating humidity sensors can be used. The humidifier 65 is controlled by the control apparatus 15 in accordance with measurement results of the humidity sensor (not shown in the drawing) which measures humidity in the air. More specifically, the control apparatus 15 controls the humidifier 65 in accordance with the measurement results of the humidity sensors so that the relative humidity in the air which is about to pass through the first impurity removing structure 54 is constant (e.g., 50%) in a range, e.g., 20 to 90%, preferably 40 to 60%, an more preferably 45 to 55%.

The first impurity removing mechanism 54 removes impurities contained in the air introduced from the air introducing port 50a into the casing 50. In the present embodiment, the first impurity removing mechanism 54 includes a chemical filter 66 which removes gaseous contaminative materials, e.g., oxide and organic compounds in air which adhere and worsen performance of the optical elements; and an ULPA filter (Ultra Low Penetration Air filter) 67 which removes particles in the air. The number of filters is not limited to one and a plurality of layered filters can be used if necessary. Also, HEPA filters (High Efficiency Particulate Air filters) can be used instead of the ULPA filters.

The chemical filter 66 can be of a type for removing, e.g. gaseous alkalic substances, gaseous acid substances, and gaseous organic compounds. More specifically, the chemical filter 66 can be, e.g., an activated carbon type (for removing gaseous organic compounds); an impregnated charcoal type (for removing gaseous alkalic substance and gaseous acid substances); an ion-exchanging fiber type (for removing gaseous alkalic substances and gaseous acid substances); an ion-exchanging resin type (for removing gaseous alkalic substances and gaseous acid substances); a ceramic type (for removing gaseous organic compounds); or an impregnated ceramic type (for removing gaseous alkalic substances and gaseous acid substances). The number of filters is not limited to one, and an arbitrary combination of different types of filter can be used. For example, a combination of the activate carbon type, the impregnated charcoal type, and the ion-exchanging resin type can be mentioned. Alternatively, a combination of the activated carbon type, the ion-exchanging fiber type (for removing gaseous acid substances), and the ion-exchanging-resin type (for removing gaseous alkalic substances) can be mentioned. Such a combination is selected in accordance with analysis with respect to atmosphere, e.g., impurities contained in the air in which the air conditioning unit 102 is disposed. With respect to the first impurity removing mechanism 54, the present embodiment is not limited to a disposition in which the chemical filter is disposed upstream and the ULPA filter 67 is disposed downstream. That is, another disposition is acceptable in which the ULPA filter 67 is disposed upstream and the chemical filter 66 is disposed downstream.

Next, the main body chamber 101 will be explained.

The inside of the main body chamber 101 is separated into blocks, i.e., the main body chamber 101 includes the above-explained exposure chamber 110 enclosing the above exposure apparatus 10; a reticle loading chamber 111 having a space containing a plurality of reticles R; and a wafer loading chamber 112 having a space containing a plurality of wafers W.

The reticle loading chamber 111 contains: a reticle library 71 which stores a plurality of reticles R; and a reticle loader 72, disposed more closer to an exposure chamber 110 than the reticle library 71, having a horizontal multi-joint robot. The reticle loader 72 carries an arbitrary one of the reticles R stored in the reticle library 71 onto the reticle stage RST and carries the reticle R disposed on the reticle stage RST into the reticle library 71.

The reticle library 71 may be replaced with, e.g., a bottom-opening-type sealed cassette (container) which can contain a plurality of reticles R. Also, the reticle loader 72 may have a mechanism which slides carriage arm. Also, the reticle library 71 may be disposed in a block different from that containing the reticle loading chamber 111. In this case, the above sealed cassette may be mounted on an upper section of the reticle loading chamber 111 so that the reticle R is carried into the reticle loading chamber 111 from an opening bottom in a sealed condition.

The wafer loading chamber 112 contains a wafer carrier 76 which stores a plurality of the wafers W, a horizontal multi-joint type robot 77 which carries the wafers W into the wafer carrier 76 and carries the wafers W from the wafer carrier 76; and a wafer carriage apparatus 78 which carries the wafers W between the horizontal multi-joint type robot 77 and the wafer stage WST.

The wafer carriage apparatus 78 may be left out, i.e., the horizontal multi-joint type robot 77 may carry the wafer W between the wafer carrier 76 and the wafer stage WST. Also, the wafer carrier 76 may be disposed in a block different from the wafer loading chamber 112.

The main body chamber 101 has a guide path 80 which introduces air from the air conditioning unit 102 through the duct 103 into the exposure chamber 110 the reticle loading chamber 111, and the wafer loading chamber 112. The air regulated by the air conditioning unit 102 is supplied to the exposure chamber 110 the reticle loading chamber 111, and the wafer loading chamber 112 via the above guide path 80.

An aperture 80a disposed at an upper end of the guide path 80 is connected to the above duct 103. A chemical filter 81, i.e., a second impurity removing mechanism is disposed near the aperture 80a. Similar for the above-explained impurity removing mechanism, any type of filter, e.g., gaseous-alkalic-substance removing type, gaseous-acid-substance removing type, or gaseous-organic compound removing type can be used for the chemical filter 81.

More specifically, the chemical filter 66 can be, e.g., an activated carbon type (for removing gaseous organic compounds); an impregnated charcoal type (for removing gaseous alkalic substances and gaseous acid substances); an ion-exchanging fiber type (for removing gaseous alkalic substances and gaseous acid substances); an ion-exchanging resin type (for removing gaseous alkalic substances and gaseous acid substances); ceramic type (for gaseous organic compounds); or an impregnated ceramic type (for removing gaseous alkalic substances and gaseous acid substances). Such a filter is not limited to one in number, i.e., an arbitrary combination of different types of filters can be used.

The guide path has filter boxes 82, 83, and 84 arranged so that the filter box 82 is disposed between a section connecting the exposure chamber 110 and the guide path; the filter box 83 is disposed between a section connecting the reticle loader 111 and the guide path; and the filter box 84 is disposed between a section connecting the wafer loading chamber 112 and the guide path. That is, the exposure chamber 110, the reticle loading chamber 111, and the wafer loading chamber 112 have respective air ventilation ports 80b, 80c, and 80d that introduce air from the air conditioning unit 102 into these chambers. The above filter boxes 82, 83, and 84 are disposed at the ventilation ports 80b, 80c, and 80d respectively. Each filter box 82, 83, and 84 is formed from an ULPA filter (Ultra Low Penetration Air filter) and a filter plenum.

Also, the main body chamber 101 has air exhaust ports 80e, 80f, 80g, and 80h that exhaust air from the main body chamber 101 to the outside. More specifically, the air exhaust ports are disposed so that the exposure apparatus 10 is disposed between the air exhaust ports 80e and 80f, where the air exhaust ports 80e and 80f correspond to air ventilation port 80b in the exposure chamber 110; the reticle library 71 and the reticle loader 72 are disposed between the air ventilation port 80c where the air exhaust port 80g in the reticle loading chamber 111 and the ports 80c and 80g correspond with respect to each other, and the wafer carrier 76, the horizontal multi-joint type robot 77, and the wafer carriage apparatus 78 are disposed between the air ventilation port 80d and the air exhaust port 80h in the wafer loading chamber 112 where the ports 80d and 80g correspond with respect to each other.

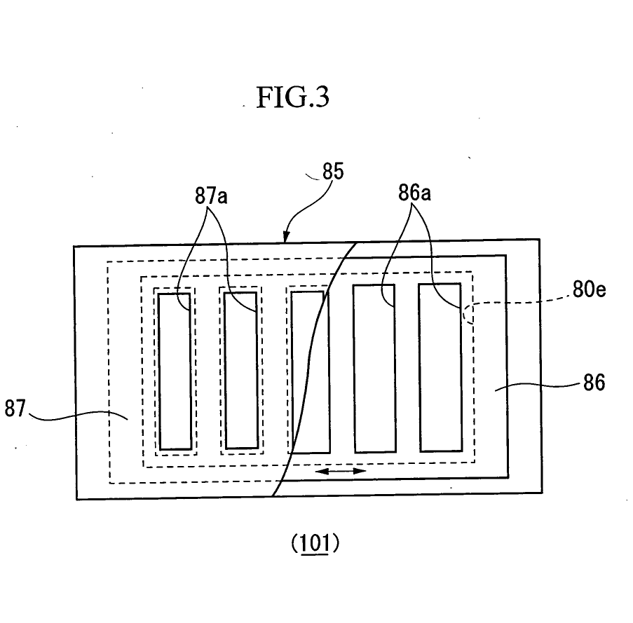

FIG. 3 is a view showing an air exhaust port 80e in the main body chamber 101.

As shown in FIG. 3, the main body chamber 101 has an exhaust regulating mechanism 85 which regulates a quantity (displacement) of air exhausted from the air exhaust port 80e. The exhaust regulating mechanism 85 includes two plate materials 86 and 87, each of which has a plurality of slit apertures 86a, and 87a. The plate material 86 is disposed to be freely movable. The size (aperture area) of the aperture of the air exhaust port 80e varies in accordance with disposition of the plate material 86. A section formed by overlapping the aperture 86a of the plate material 86 and the aperture 87a of the plate material 87 is an aperture of the air exhaust port 80e. That is, air is blocked by the non-overlapping section. In the present embodiment, the disposition of the plate material 86 is adjusted directly by an operator. The disposition of the plate material 86 may be adjusted by a driving apparatus. Similarly to in the above-explained air exhaust port 80e, air regulating mechanisms that regulate displacement are disposed for other air exhaust ports 80f to 80h (see FIG. 1) in the main body chamber 101. That is, displacement from the exposure chamber 110 is regulated by regulating the size of the apertures of the air exhaust ports 80e and 80f. Displacement from the reticle loading chamber 111 is regulated by regulating the size of the aperture of the air exhaust port 80g. Displacement from the wafer loading chamber 112 is regulated by regulating the size of the aperture of the air exhaust port 80h.

As shown in FIG. 1, a box 16 contains various elements including the control apparatus 15. The box 16 is isolated in the main body chamber 101 so that air can be exhausted by a small fan 17 from the box 16 through the main body chamber 101 and an air exhaust port 16a. Also, a local circulating system 87 and separating members 88 shown in FIG. 1 disposed in the main body chamber 101 will be explained later.

Next, air conditioning operation conducted with respect to the main body chamber 101 by the above atmosphere control apparatus 100 is explained.

Firstly, a fan 51 starts moving in the air conditioning unit 102. Air attracted by the fan 51 is introduced into the air conditioning unit 102 (casing 50) from an air introducing port 50a. Air pressure in downstream from the fan 51 increases. Air pressure decreases upstream thereof. The air is introduced from the air introducing port 50a into the air conditioning unit 102 without passing through an impurity removing filter; therefore, load applied to the fan 51 is relatively low.

The air conditioning unit 102 regulates the temperature of the air introduced from the air introducing port 50a to keep it at a target temperature using a temperature regulating mechanism 52 and regulates the humidity of air to keep it at a target humidity using a humidity control mechanism 53. Material contaminative with respect to the various optical elements, e.g., gaseous alkalic substances, gaseous acid substances, or gaseous organic compounds can be absorbed (removed) almost fully from the temperature-and-humidity-controlled air which passes through the chemical filter 66 in the first impurity removing mechanism 54. In addition, particles can be removed almost fully from the air which passes through the ULPA filter 67.

The air having undergone predetermined air-conditioning, e.g., for removing impurities and regulating temperature, is supplied to the main body chamber 101 through the duct 103. More specifically, the air, having undergone air conditioning in the air conditioning unit 102, passes through the duct 103 and flows into the guide path 80 in the main body chamber 101. After that, the air is supplied to the exposure chamber 110; the reticle loading chamber 111, and the wafer loading chamber 112.

The chemical filter 81 is disposed at the aperture 80a of the guide path 80 from which air is introduced into the main body chamber 101. The filter boxes (ULPA filters) 82, 83, and 84 are disposed at the air ventilation ports 80b, 80c, and 80d from which air is introduced into the exposure chamber 110, the reticle loading chamber 111, and the wafer loading chamber 112. Impurities (e.g., particles) are removed from the air by these filters 81 to 84. That is, impurities are prevented from entering the chambers 110, 111, and 112 more reliably.

Conditions of the atmosphere, e.g., cleanliness, temperature, and humidity in each chamber 110, 111, and 112 filled by the supplied air are controlled to be target condition. Source of the air is exhausted from the main body chamber 101 to the outside through the air exhaust ports 80e, 80f, 80g, and 80h. That is, the air introduced into the air conditioning unit 102 is exhausted from the main body chamber 101 to the outside.

As explained above, with respect to air conditioning, overall air-flow in the atmosphere control apparatus 100 of the present embodiment is one way, i.e., in accordance with a one-path method where air flows from the air conditioning unit 102 toward the main body chamber 101. Therefore, air pressure in air-flow paths formed between the fan 51 and the air exhaust ports 80e, 80f, 80g, and 80h formed on the main body chamber 101 can be maintained higher than air pressure out of the main body chamber 101. In addition, there are no areas in the air flow paths formed between the fan 51 and the air exhaust ports 80e, 80f, 80g, and 80h having lower air pressure than the air pressure in external atmosphere thereof; therefore, the air (external atmosphere) is prevented from entering the main body chamber 101. Accordingly, impurities are prevented from entering the main body chamber 101, and fluctuation with respect to air temperature is prevented.

With respect to air conditioning, air-flow in the atmosphere control apparatus 100 of the present embodiment is one way; therefore, impurities produced in the main body chamber 101 are exhausted from the main body chamber, where the impurities may be e.g., volatile compounds evaporated from photo-resist coated on the wafer W, volatile compounds evaporated from anti-friction agent used in elements forming various driving sections, and volatile compounds evaporated from a coating layer of wirings used to supply electricity and signals to electric parts. If air is circulated in the main body chamber 101, there is concern that such impurities accumulating in the circulating air may damage filters disposed in the circulation paths. However, the present embodiment is free from such concern.

The size of the aperture (aperture area) of each air exhaust port 80e, 80f, 80g, and 80h is regulated by the exhaust regulating mechanism 85 in air-conditioning in the present embodiment of the atmosphere control apparatus 100. By doing this, air pressure in the main body chamber 101 can be regulated. For example, it is possible to increase air pressure in the exposure chamber 110 by narrowing the aperture area of each air exhaust port 80e and 80f so as to decrease the displacement from the exposure chamber 110. The other air exhaust ports 80g an 80h can be regulated similarly.

The atmosphere control apparatus 100 is advantageous in increasing pressure in each chamber 110, 111, and 112 because the air ventilation port 80b face the air exhaust ports 80e and 80f respectively so that the exposure chamber 110 is provided therebetween; the air ventilation port 80c faces the air exhaust port 80g respectively so that the reticle loading chamber 111 is provided therebetween; and the air ventilation port 80d face the air exhaust port 80h respectively so that the wafer loading chamber 112 is provided therebetween. In each chamber 110, 111, and 112, the apparatus, e.g., the exposure apparatus 10, the reticle loader 72, or the wafer carriage apparatus 78 is disposed between air introducing ports and air exhaust ports. Therefore, the apparatuses disposed in an air-flow in each chamber can increase air pressure.

Regulation of the aperture ratio of each air exhaust port 80e, 80f, 80g, and 80h independently enables control of pressure differences among the chambers 110, 111, and 112. By doing this, it is possible to regulate air pressure in each chamber in accordance with priority with respect to cleanliness of that chamber.

As explained above, it is possible to increase air pressure in the main body chamber 101 in the present embodiment of the atmosphere control apparatus 100. Therefore, it is possible to maintain air pressure in the main body chamber 100 higher than air pressure in external atmosphere because the air pressure in the main body chamber 100 has been set high in view of pressure differences among a plurality of separated areas disposed in a clean room; and the main body chamber 101 disposed over the separated areas. Therefore, it is possible to prevent external atmosphere from entering the main body chamber 101 reliably.

The temperature regulating mechanism 52 (cooler 60, heater 61) and the humidity regulator 53 (humidifier 65) are disposed between the fan 51 and the air introducing port 50a, i.e., upstream from the fan 51 in the present embodiment of the atmosphere control apparatus 100. This disposition is free from air-flow drag due to air compression by the fan 51. Therefore, air pressure can be increased reliably downstream from the fan 51.

As explained above, the fan 51 is disposed between the air introducing port 50a and the first impurity removing mechanism 54 in the air conditioning unit 102 in the present embodiment of the atmosphere control apparatus 100. Air pressure decreases between the fan 51 and the air introducing port 50a, i.e., upstream from the fan 51. However, air pressure increases downstream from the fan 51.

The first impurity removing mechanism 54 (chemical filter 66, ULPA filter 67) is disposed downstream having high air pressure from the fan 51. By this disposition, external atmosphere is prevented from eluding the first impurity removing mechanism 54 before entering the main body chamber 101. That is, air pressure is higher than in sections between the fan 51 and the first impurity removing mechanism 54; and between the first impurity removing mechanism 54 and the main body chamber 101. Therefore, external atmosphere is prevented from entering the air-flow paths.

All the air supplied to the main body chamber 101 passes through the first impurity removing mechanism 54 reliably. Contaminants included in the supplied air are removed by the first impurity removing mechanism 54. Thus, the density of impurities with respect to each chamber 110, 111, and 112 represents the filtering capability of the first impurity removing mechanism 54. For example, density of organic compounds in the air which has passed through the air conditioning unit 102 is 10 μg/m³ or lower where the total density of organic compounds contained in air introduced into the air conditioning unit 102 is 100 μg/m³, and the filtering capability of the first impurity removing mechanism 54 (chemical filter 66) is 90%. The density of organic compounds in the air which has been introduced into each chamber 110, 111, and 112 contained in the main body chamber 101 is 2 μg/m³ or lower where the filtering capability of the chemical filter 81 (second impurity removing mechanism) is 80%.

The air conditioning unit 102 is provided with a driving unit, e.g., the fan 51. The exposure apparatus 10 is provided with driving units, e.g., the reticle blind 29, the reticle stage RST, and the wafer stage WST. In addition, an anti-friction agent is used in elements forming these driving units. In the present embodiment, fluorine grease is used for the anti-friction agent having a relatively less volatile compound (organic compound, e.g., carbide). Toluene-based quantity of compound evaporated from the fluorine grease is 150 μg/m³ or less where about the 10 mg of fluorine grease is heated at 60° C. for ten minutes in nitrogen atmosphere. In particular, toluene-based quantity of compound evaporated from the fluorine grease is preferably 100 μg/m³ or less under the same heating conditions. Toluene-based quantity of compound evaporated from the fluorine grease is more preferably 40 μg/m³ or less under the same heating conditions. DEMNUM (trademark registered by DAIKIN INDUSTRIES, LTD.) is known as such a grease.

Compound is prevented from evaporating from the grease if the above fluorine grease is applied to sliding sections in the driving units disposed in the air conditioning unit 102 and the exposure apparatus 10. Therefore, it is possible to use the chemical filter 66 in the air conditioning unit 102 and the chemical filter 81 in the main body chamber 101 for a long time.

Next, a local circulating system 87 and separating members 88 disposed in the main body chamber 101 are explained.

As shown in FIGS. 1 and 2, the local circulating system 87 has an air conditioning section 120 which regulates the temperature and humidity of introduced air and a circulation path 121 in which the air circulates. The local circulating system circulates introduced air in the exposure chamber 110 locally. The local circulating system 87 of the present embodiment circulates the air in a local space surrounding the reticle stage RST and the wafer stage WST in the exposure chamber 110.

The air conditioning section 120 includes a cooler 123 which regulates the temperature of the air, a fan 124 which introduces the air, and an impurity removing mechanism 125, which are disposed in this order with respect to air-flow direction in a casing 122 disposed outside of the adjacent main body chamber 101. Similarly to the above cooler 60, the cooler 123 regulates the temperature of air introduced into the casing 122 to keep it at a predetermined temperature in accordance with measurement results of temperature sensors (not shown in the drawings). The air-blowing-capability of the fan 124 is lower than that of the fan 51 used in the above air conditioning unit 102 (see FIG. 1). The impurity removing mechanism 125 includes a chemical filter 126 (upstream from an ULPA filter) which removes gaseous contaminative materials, e.g., oxygen and organic compounds in the air which adhere and worsen optical performance of optical elements; and the ULPA filter (downstream from the chemical filter 126) 127 which removes particles in the air, similarly to in the above explained first impurity removing mechanism 54. The number of each filter above is not limited to one and a plurality of layered filters can be used if necessary. Any type of filter, e.g., gaseous-alkalic-substance removing type, gaseous-acid-substance removing type, or gaseous-organic-substance removing type can be used for the chemical filter 126.

The circulation path 121 includes a first air introducing port 130 which introduces air from the exposure chamber 110, a second air introducing port 131 which introduces air from a main body column 36, a first ventilation port 132 disposed toward an optical axis of an interferometer 33 for measuring the position of the reticle stage RST, a second ventilation port 133 disposed toward an optical axis of an interferometer 34 for measuring the position of the wafer stage WST, a third ventilation port 134 disposed toward optical axes of auto-focus sensors 24 for measuring the position of the wafer stage WST, and a fourth ventilation port 135 disposed on a side wall of a wafer chamber 40. The circulation path 121 has a divided structure corresponding to the above explained air ventilation ports 132 to 135 so that the air introduced from the air introducing ports 130 and 131 is supplied to the air conditioning section 120; and the air supplied from the air conditioning section 120 is divided into the above air ventilation ports 132 to 135 respectively.

An ULPA filter 140, i.e., an impurity removing mechanism which further removes particles contained in the air supplied from the air conditioning section 120 is disposed in the circulation path 121. The ULPA filter 140 is disposed upstream from the dividing section which divides the air supplied from the air conditioning unit 120 into the air ventilation ports 132 to 135.

In addition, temperature stabilizing units 141 and 142, which mitigate unevenness of the temperature of air supplied from the air conditioning section 120, are disposed in the circulation path 121. The temperature stabilizing unit 141 is disposed in paths through which the air flows to the reticle stage RST. The temperature stabilizing unit 142 is disposed in paths through which the air flows to the wafer stage WST. The temperature stabilizing unit 141 includes pipes 141a disposed in contact with air flowing in the circulation path 121. The temperature stabilizing unit 142 includes pipes 142a disposed in contact with air flowing in the circulation path 121. A temperature-controlled liquid medium flows in these pipes 141a and 142a. The temperature of the air flowing in the circulation path 121 is equalized due to contact with these pipes 141a and 142a.

The local circulating system 87 having the above explained structure including the circulation path 121 circulates the air by using the fan 124 rotating in the air conditioning unit 120. More specifically, the temperature of air introduced from the air introducing ports 130 and 131 is regulated by the cooler 123. In addition, contaminants and particles contained in the temperature-controlled air are removed by the impurity removing mechanism 125 (chemical filter 126, ULPA filter 127). The air which passes through the air conditioning unit 120 flows in the circulation path 121 so that particles contained therein are removed by the ULPA filter 140. In addition, the temperature stabilizing units 141 and 142 mitigate unevenness of the temperature of the flowing air. The temperature-and-cleanliness-regulated air is supplied to a space in which the reticle stage RST is disposed through the air ventilation port 132. The air is further supplied to a space in which the wafer stage WST is disposed from the air ventilation ports 133 to 135. Thus, the spaces containing the reticle stage RST and the wafer stage WST are filled with the air having the temperature regulated by the air conditioning unit 120.

Next, the separating members 88 will be explained.

As shown in FIG. 1, the separating members isolate a space in which the exposure apparatus 10 is disposed from the rest the of space in the exposure chamber 110. The separating members 88 of the present embodiment are made of a sheet material and are disposed to surround the air ventilation port 80b (filter box 82) formed on the exposure chamber 110, and a part of the exposure apparatus 10 (e.g., the illuminating system 21, the reticle stage RST (see FIG. 2)). The separating members 88 are made of relatively less contaminative materials so that optical performance of the optical elements is not worsened. Chemically-cleaned separating members 88 are used if necessary.

More specifically, ethylene-vinylalcohol copolymerization resin (e.g., EVAL: trademark registered by KURARAY CO., LTD.), polyimide film (e.g., KAPTON: trademark registered by TORAY INDUSTRIES, INC.), and polyethylene terephthalate (PET) film (e.g., MYLAR: trademark registered by DUPONT) can be mentioned for the sheet material. In addition, various materials can be named for the sheet material including: various fluororopolymers, e.g.,

tetrafluoroethylene (i.e., TEFLON: trademark registered by DUPONT),
tetrafluoroethylene-perfluoro(alkylvinyl ether),
tetrafluoroethylene-hexafluoropropene copolymer,
and a so-called three-layered-high-barrier sheet, e.g.,
(nylon (ONY polymerization)-one-side-silica-coated PET resin (PET 12)-polyethylene (PEF60)).

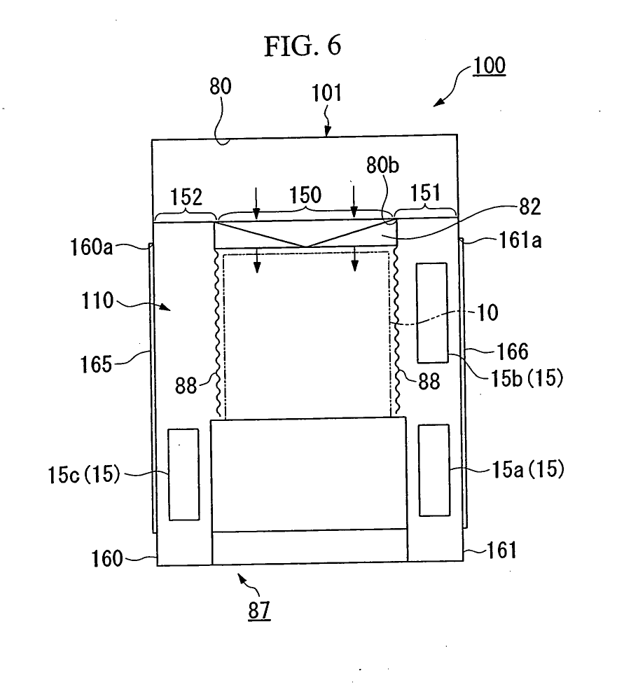

FIG. 6 is a view showing dispositions of regulating sections. As shown in FIG. 6. the exposure chamber 110 includes spaces, i.e., a space (a first space 150) in which important sections of the exposure main body section 10 are disposed; another space (a second space 151) in which a control apparatus 15 (e.g., the temperature regulating mechanism 15a and an electric control section 15b to be explained later) is disposed; and a space (a second space 152) in which the control apparatus 15 (e.g., a gas pressure control section 15c to be explained later) is disposed.

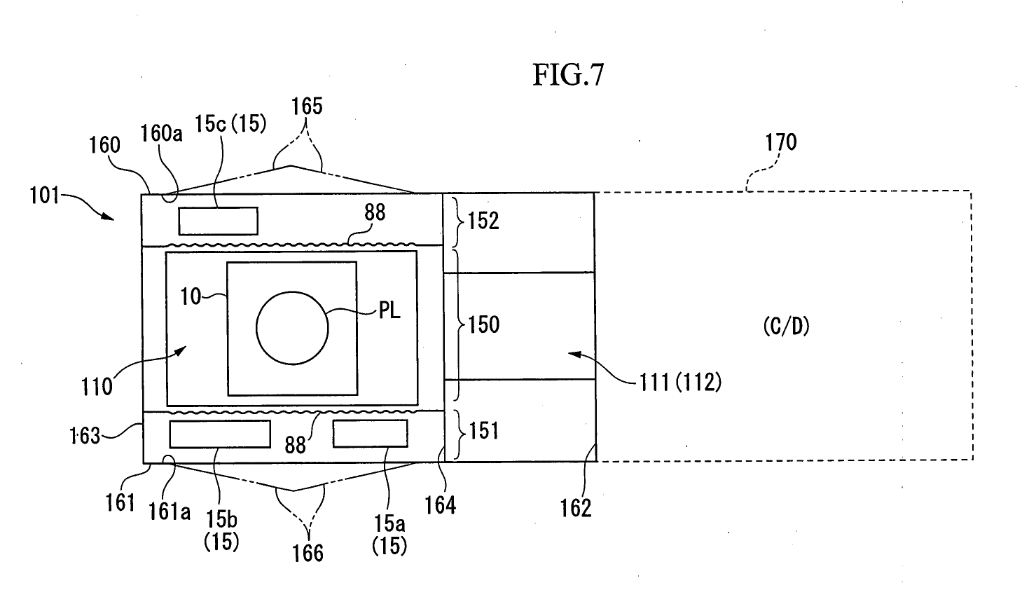

FIG. 7 is a plan view showing the disposition of separating members 88.

As shown in FIG. 7, the main body chamber 101 has four side walls 160, 161, 162, and 163 disposed so that the side wall 162 which contacts the reticle loading chamber 111 (and the wafer loading chamber 112) is disposed to face a chamber 170 which contains a coater/developer (C/D) which coats photo-resist on a wafer and develops the resist-coated wafer. Apertures 160a and 161a used for maintenance are formed on two side walls 160 and 161 which are disposed orthogonally with respect to the side wall 162 so as to face each other. Freely movable doors 165 and 166 are disposed at the apertures 160a and 161a respectively. The separating members 88 are disposed so that both ends of each separating member 88 contact the side wall 163 and the side wall 164, and the side wall 164 separates the exposure chamber 110 from the reticle loading chamber 111 (and the wafer loading chamber 112). In the present embodiment of the exposure chamber 110 of the main body chamber 101, important sections (e.g., projection optical system PL) of the exposure main body section 10 are disposed between the separating members 88. The separating members are freely movable, i.e., they are closed in the exposure processes.

As explained above, the important sections (e.g., the illuminating system 21, the reticle stage RST, and the wafer stage WST (see FIG. 3)) of the exposure main body section 10, i.e., the first elements are disposed in the space surrounded by the separating members 88 and the side walls 163 and 164 in the main body chamber 101 (exposure chamber 110). The second elements, i.e., the control apparatuses 15, are disposed in spaces thereoutside, i.e., the space 152 between the separating members 88 and the side wall 160; and the space 151 between the separating members 88 and the side wall 161. The control apparatuses 15 include, e.g., the temperature regulating mechanism 15a which regulates the temperature of the exposure main body section 10, the electric control section 15b which controls the exposure main body section 10 electrically, and the gas pressure control section 15c which regulates the pressure of gas used in the exposure main body section 10, all of which must be subjected to maintenance regularly.

Returning to FIGS. 1 and 6, the local circulating system 87 and the separating members 88 are disposed in the main body chamber 101 having the above explained structure. Thus, the air pressure in the first space 150, which includes a space in which the reticle stage RST is disposed and a space in which the wafer stage WST is disposed, is higher than the air pressure in the rest of space (second spaces 151 and 152) in the main body chamber 101; therefore, external atmosphere is prevented from entering the first space 150. The air supplied to the main body chamber 101 is controlled, e.g., the temperature is regulated and impurities are removed before it circulates in the local circulating system 87. Therefore, cleanliness thereof is high, and the temperature is stable. Air fluctuation (temperature fluctuation) is prevented in the first space 150 because the first space 150 is filled with the circulating air. Therefore, positions of the stages RST and WST are accurately controlled, i.e., measured by the interferometers 33 and 34 (see FIG. 2). Therefore, the position of each stage RST and WST is set in the exposure main body section 10; thus, the exposure processes are conducted accurately.

As shown in FIG. 6, air-flow introduced from the air ventilation port 80b is controlled using the separating members 88 in the exposure chamber 110 in the main body chamber 101. That is, the air introduced from the air ventilation port 80b, which is surrounded by the separating members 88 and the side walls 163 and 164 (see FIG. 7), into the exposure chamber 110 flows to the exposure main body section 10 along the separating members 88 so that air-flow in other directions is restricted. The external atmosphere is prevented from entering the local circulating system 87 more reliably because air-flow direction is controlled by the separating members 88 and air pressure increases in the first space 150. Also, external atmosphere is prevented from entering spaces in which important sections of the exposure main body section 10 in the exposure chamber 110 are disposed; therefore, accuracy can be improved with respect to controlling temperature and cleanliness of the atmosphere in the present embodiment of the atmosphere control apparatus 100. The exposure processes can be conducted accurately in the exposure apparatus 10 in the main body chamber 101 accordingly.

As shown in FIG. 7, the control apparatuses 15 (the temperature regulating mechanism 15a, the electric control section 15b, and the gas pressure control section 15c) are subjected to maintenance using the apertures 160a and 161a formed on the main body chamber 101. That is, the operator subjects the control apparatuses 15 to maintenance by opening the door 166 (or the door 165) in the main body chamber 101. The separating member 88 is closed not only during the exposure processes but also during maintenance. That is, the separating members 88 become walls which prevent air from flowing from the second spaces 151, and 152, in which the control apparatuses 15 are disposed, to the first space 150. Therefore, the separating members 88 prevent external atmosphere in the main body chamber 101 from entering the first space 150.

Maintenance for the above control apparatuses 15 is conducted similarly to the exposure processes, i.e., air is introduced by the air conditioning unit 102 from the air ventilation port 80b into the exposure chamber 110, and the air is circulated by the local circulating system 87 so that air pressure in the first space 150 is higher than air pressure in the second spaces 151, 152. The air is prevented from flowing from the second spaces 151 and 152 into the first space 150 because the direction of the air-flow is one-way, i.e., from the first space 150, having controlled higher air pressure, to the second spaces 151 and 152 during the maintenance of the above control apparatuses 15. Therefore, external atmosphere is prevented from entering the first space 150 more reliably.

Elements disposed in the first space 150 in the exposure main body section 10 are subjected to maintenance using the apertures 160a, 161a, and the separating members 88. That is, the operator subjects important sections in the exposure main body section 10 to maintenance by opening the door 165 (or the door 166) of the main body chamber 101 and opening the separating members 88. After the maintenance is completed, the operator conducts the following operations, i.e., closing the separating members 88; supplying air using the air conditioning unit 102 from the air ventilation port 80b into the exposure chamber 110; and circulating the air using the local circulating system 87, so that the atmosphere in the first space 150 is controlled to be in a desirable condition. The above operations, i.e., supplying air using the air conditioning unit 102 from the air ventilation port 80b into the exposure chamber 110; and circulating the air using the local circulating system 87, may be conducted during the maintenance for the elements disposed in the first space 150. The above air conditioning operation enables maintaining the higher air pressure in the first space 150 than air pressure in the second spaces 151 and 152; thus, it is possible to prevent external atmosphere from entering the first space 150.

As explained above, external atmosphere is prevented from entering the first space 150 in which important sections of the exposure main body section 10 are disposed in the present embodiment not only during the exposure processes but also during maintenance. Therefore, the atmosphere, i.e., temperature and cleanliness, in the first space 150 can be controlled highly accurately and time necessary for removing external atmosphere which has entered the first space 150 can be reduced.

In particular, the air conditioning unit 102 controls, i.e., regulates the air pressure in the first space 150 to make it higher than the air pressure in the second spaces 151 and 152 during the maintenance of the control apparatuses 15 (the temperature regulating mechanism 15a, the electric control section 15b, and the gas pressure control section 15c), which must be maintained frequently in the present embodiment. Therefore, external atmosphere is prevented from entering the first space 150 reliably. By doing this, turbulence of atmosphere in the sections for conducting exposure processes is prevented in the atmosphere control apparatus 100; therefore, processes conducted therein can be stable.

The separating members 88 of the present invention are not limited to the sheet materials used in the above embodiment. The separating members 88 may be, e.g., plate materials. The sheet material is advantageous in that they can open and close freely in limited spaces.

Although the above embodiment is explained with reference to an example in which the separating members 88 are disposed in the main body chamber 101 which contains the exposure main body section 10, additional separating members may be disposed in the chamber 170 which contains the coater/developer (C/D) so that external atmosphere is prevented from entering important sections.

With respect to disposition from a space-saving point of view in the above embodiment, the main body chamber 101 in the exposure apparatus 10 is disposed as high as the chamber 170 in the coater/developer (C/D) and the widths of the chambers are approximately the same. Thus, space for the chambers is effectively saved.

The side wall 160 having the maintenance aperture 160a and side wall 161 having the maintenance aperture 161a each have a surface area larger than a surface area of the side walls 162 and 163 facing toward the coater/developer (C/D) in the main body chamber 101 in the exposure apparatus 100. Differentiating the surface areas of the side walls is advantageous because mass maintenance can be conducted easily, e.g., the wafer stage WST can be extracted through the apertures 160a and 161a, and also maintenance capability is improved.

The above explained air conditioning unit 102 is provided with a driving unit, e.g., the fan 51. The exposure apparatus 10 is provided with driving units, e.g., the reticle blind 29, the reticle stage RST, and the wafer stage WST. In addition, an anti-friction agent is used in elements forming these driving units. In the present embodiment, fluorine grease is used as an anti-friction agent having a rather less volatile compound (organic compound, e.g., carbide). Toluene-based quantity of compound evaporated from the fluorine grease is 150 μg/m³ or less where about the 10 mg of fluorine grease is heated at 60° C. for ten minutes in a nitrogen atmosphere. In particular, it is preferable that toluene-based quantity of compound evaporated from the fluorine grease is 100 μg/m³ or less under the same heating condition. It is more preferable that toluene-based quantity of compound evaporated from the fluorine grease be 40 μg/m³ or less under the same heating condition. DEMNUM (trademark registered by DAIKIN INDUSTRIES, LTD.) is known as such a grease.

Also, compound in the grease is prevented from evaporating therefrom if the above fluorine grease is applied to sliding sections in the driving units disposed in the air conditioning unit 102 and the exposure apparatus 10. Therefore, it is possible to use the chemical filter 66 in the air conditioning unit 102 and the chemical filter 81 in the main body chamber 101 for a long time.

The air conditioning unit 102 of the present invention is not limited to the present embodiment in which the casing 50 of the air conditioning unit 102 includes the fan 51, the temperature regulating mechanism 52, the humidity regulating mechanism 53, and the first impurity removing mechanism 54.

The first impurity removing mechanism 54 may be left out of the air conditioning unit 102. Also, the duct 103 may contain the temperature regulating mechanism 52, the humidity regulating mechanism 53, and the first impurity removing mechanism 54, while the air conditioning unit 102 may include only the fan 51.

Air-supplying paths in the main body chamber 101 may contain the chemical filter 81 (second impurity removing mechanism) and additional impurity removing mechanisms.

In addition, the local circulating system 87 may be designed to use a one-path method similar to the main body chamber 101. By doing this, atmosphere can be controlled accurately.

The filters used in the air conditioning unit 102 which introduces air from the outside may be more quickly deteriorated than filters used in the main body chamber. Therefore, it is preferable that the air conditioning unit 102 have a filter-exchanging mechanism.

Also, the device-manufacturing apparatus of the present invention is not limited to an exposure apparatus but can be another apparatus, e.g., a coater/developer which coats photo-resist on substrates and develops the resist-coated substrates.

The exposure apparatus 10 of the present invention is not limited to a structure in which the main body chamber 101 contains the main column 36. The reticle chamber and wafer chamber may be separate chambers having a projection optical system therebetween.

The projection optical system may be a refracting-type, reflecting-and-refracting type, and reflecting type. The present invention can be used for non-projection-type exposure apparatus, e.g. a contact-type exposure apparatus in which mask patterns are exposed by contacting the mask and a substrate, or a proximity-type exposure apparatus in which mask patterns are exposed by approaching the mask to a substrate.

The exposure apparatus is not limited to a reduction-exposure type but may be of, e.g. a 1× magnification-exposure type, or magnifying-exposure type.

The present invention can be used to not only micro-devices, e.g., semiconductor elements but also as an exposure apparatus which uses mother reticles to manufacture reticles/masks used in various apparatuses, e.g., an optical exposure apparatus, an EUV exposure apparatus, an X-ray exposure apparatus, or an electro-beam exposure apparatus, in all of which circuit patterns are transferred onto glass substrates and silicon wafers. Transmissive reticles are commonly used in exposure apparatuses which use DUV rays (deep ultra violet rays) and VUS rays (vacuum ultra violet rays). Materials for substrates used for the reticle are, e.g., quartz glass, fluorine-doped quartz glass, fluorite, magnesium fluoride, or crystal. Transmissive masks, e.g., stencil masks and membrane masks, are used in the X-ray exposure apparatus and the electronic beam exposure apparatus, both of which use proximity method. The material for substrates used for the mask is, e.g., a silicon wafer.

The present invention can be used in not only an exposure apparatus for manufacturing semiconductors but also for the following exposure apparatuses: an exposure apparatus used for manufacturing displays including liquid crystal display (LCD) elements, in which device patterns are transferred onto glass plates, an exposure apparatus used for manufacturing thin film magnetic heads, in which device patterns are transferred onto wafers, e.g., ceramic wafers, an exposure apparatus used for manufacturing image-capturing elements, e.g., CCDs (charge coupled devices), and a block-wise exposure apparatus, using a step-and-repeat method in which mask patterns are transferred onto substrates while the masks and the substrates are fixed and the substrate is moved in a step manner.

A light source of the exposure apparatus may be, e.g., g-line (λ=436 nm), i-line (λ=365 nm), KrF excimer laser (λ=248 nm), F₂ laser (λ=157 nm), Kr₂ laser (λ=146 nm), or Ar₂ laser (λ=126 nm). Also, the light source may be e.g., infrared rays oscillated from a DFB semiconductor laser or a fiber laser, or harmonics produced by amplifying a laser beam having a visible single-wavelength by using an erbium-doped fiber amplifier (or erbium-and-ytterbium-doped fiber amplifier), and inverting the amplified laser beam into an ultra violet ray using a non-linear optical crystal.

The above explained exposure apparatus 10 is manufactured as follows.

First, a plurality of lens elements 31 and cover glasses are put into a lens barrel (casing 43) in order to form a projection optical system PL. An illuminating system 21 including optical members, e.g., a mirror 27 and lenses 26 and 28 are put into a casing 42. The illuminating system 21 and the projection optical system PL are assembled with the main body chamber 101 and adjusted optically. Next, the wafer stage WST including mechanical parts (the reticle stage RST is included if the exposure apparatus is of the scanning-type) is mounted on the main body chamber 101. The wafer stage WST and the main body chamber 101 are connected using wiring.

A supply pipe 45 and an exhaust pipe 46 are connected to casings, e.g., a casing 41 containing the BMU 12; a casing 42 containing the illuminating system 21; and a casing 43 containing the projection optical system PL. Also, the air conditioning unit 102 is connected to the main body chamber 101 via the duct 103. After that, comprehensive adjustments, e.g., electrical adjustment and movement adjustment are conducted.

Elements forming the casings 41, 42, and 43 are cleaned by using ultrasonic cleaning apparatuses before assembly so as to eliminate oils and metal compounds attached thereto during manufacturing of the casings. The exposure apparatus 10 is preferably manufactured in a clean room in which temperature, humidity and cleanliness are controlled.

Next, an embodiment of the device-manufacturing method using the above explained exposure apparatus 10 in lithographic processes is explained.

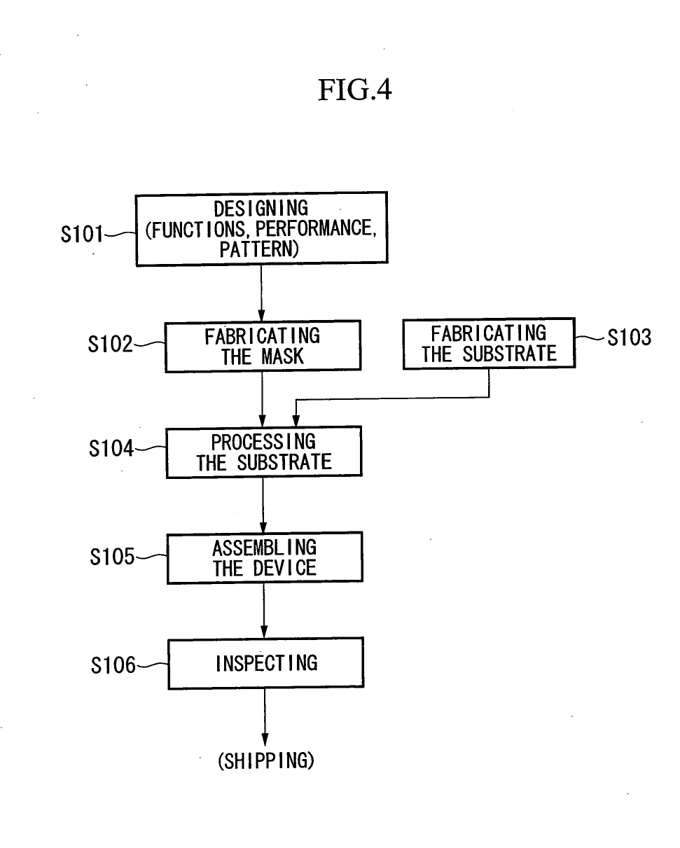

FIG. 4 is an example of a flow chart for manufacturing devices (e.g., semiconductor devices including ICs and LSIs, liquid crystal display elements, image-capturing elements (e.g., CCDs), thin film magnetic heads, and micro-machines).

As shown in FIG. 4, the function/capabilities of the devices (micro-devices) are designed (e.g., designing semiconductor device circuit), and circuit pattern is designed for realizing the designed function in step S101. Next, masks (e.g., reticles R) having the designed circuit pattern are manufactured in step S102 (mask-manufacturing step). Also, a substrate (wafers W are used if the substrates are made from a silicon material) is made from various materials, e.g., silicon or glass plates in step S103.

As explained later, circuits are actually formed on the substrates in step S104, using, e.g., a lithographic method in which the masks and substrates manufactured in steps S101 to S103 are used. The substrates manufactured in step S104 are assembled into devices in step S105 (device-assembling step). Step S105 may include, e.g., a dicing-step, a bonding-step, and a packaging-step (i.e., chip-sealing step) if necessary.

With respect to the devices manufactured in step S105, tests, e.g., operation test and durability test are conducted in step S106 (inspecting-step). The devices manufactured in these steps are shipped from a factory.

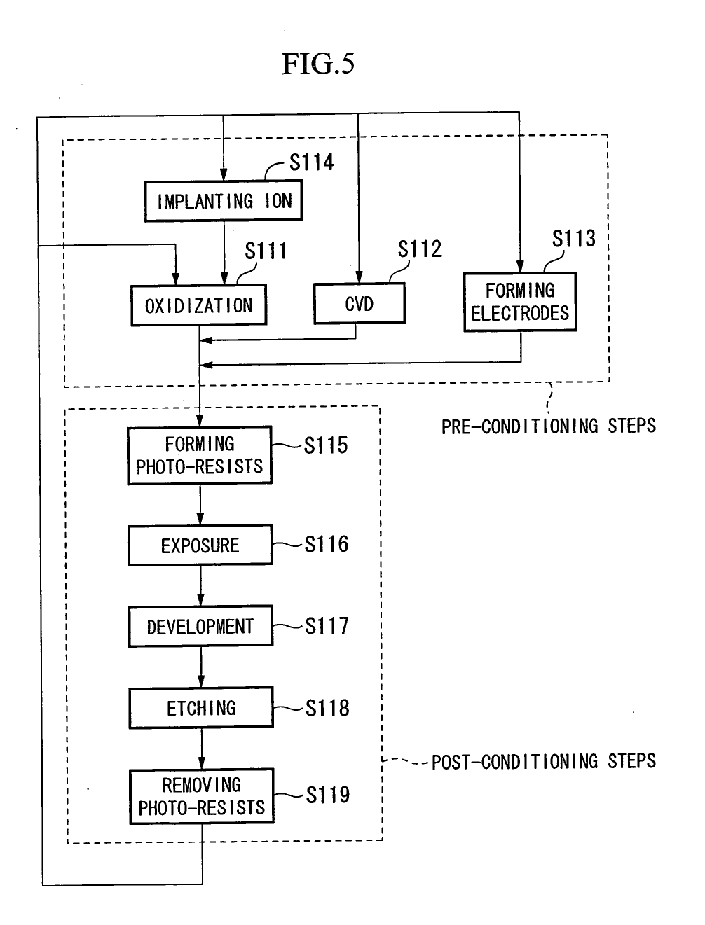

FIG. 5 is a view showing an example of a detailed flow chart with respect to manufacturing semiconductor devices in step S104 shown in FIG. 4. As shown in FIG. 5, wafer surfaces are oxidized in step S111 (oxidizing-step). An insulating layer is formed on the wafer surface in step S112 (CVD step). Electrodes are formed on the wafer using a vapor deposition method in step S113 (electrode-forming step). Ions are implanted onto the wafer in step S114 (ion-implanting step). Steps S111 to S114 are pre-conditioning steps to be conducted before each wafer process, so necessary pre-conditioning steps are selected and conducted.

After the pre-conditioning steps with respect to each wafer process, post-conditioning steps are conducted as follows. With respect to the post-conditioning steps, a photosensitive material is put onto a wafer in step S115 (photo-resist-forming step). Circuit patterns formed on the masks (reticles) are transferred onto the wafers by the above explained lithographic system (exposure apparatus) in step S116 (exposure step). The exposed wafers are developed in step S117 (developing step). Sections, exposed but not having the photo-resist, are removed from the wafer by etching in step S118 (etching step). Photo-resist remaining after etching the wafer is removed in step S119 (photo-resist-removing step).

Wafers having multiple circuit patterns are obtained by repeating these pre-conditioning steps and post-conditioning steps.

Resolution of the exposure light beam can be improved in the present embodiment of the device-manufacturing apparatus in the exposure step (step S116); therefore, it is possible to control amplitude of the exposure light beam highly accurately. Therefore, the exposure accuracy can be improved, i.e., it is possible to manufacture devices having a high degree of exposure accuracy, e.g., several tenths of a micrometer of circuit line width at a desirable product yield.

It is obvious that the present invention is not limited to the above explained preferable embodiments explained with reference to the attached drawings. It would also obvious to a person having ordinary skill in the art that various modifications and adjustments can be imagined within the scope of technical ideas disclosed in the present application. The inventor of the present invention believes that such modifications and corrections certainly belong to the scope of the technical ideas disclosed in the present application.

Since external atmosphere is prevented from entering the chamber in the atmosphere control apparatus of the present invention, it is possible to control the atmosphere in the chamber very accurately.

Also, since the devices are manufactured in the highly-accurately-controlled atmosphere in the device-manufacturing apparatus and the device-manufacturing method of the present invention, it is possible to improve the quality of the devices.

Since the external atmosphere is prevented by the separating member from entering the chamber during maintenance in accordance with the exposure apparatus of the present invention, the exposure process can be conducted stably.

What is claimed is:

1. An atmosphere control device comprising:
a chamber which encloses at least a part of a device-manufacturing apparatus;
an air introducing mechanism which introduces air and sends the introduced air into the chamber;
air exhaust ports which exhaust the air, introduced by the air introducing mechanism, from the chamber to the outside; and
a local circulating system which sends the air from the chamber to a local space of the device-manufacturing apparatus, including a predetermined part of the device-manufacturing apparatus; and circulates the air in the local space.

2. An atmosphere control apparatus according to claim 1, wherein the local circulating system has at least one of:
a temperature regulating mechanism which regulates a temperature of introduced air;
the air introducing mechanism, disposed downstream from the temperature regulating mechanism, which introduces the air introduced from the chamber; and
an impurity removing mechanism, disposed downstream from the air introducing mechanism, which removes impurities contained in the introduced air.

3. An atmosphere control apparatus according to claim 1, wherein the device-manufacturing apparatus is an exposure apparatus which transfers patterns formed on masks onto photosensitive substrates.

4. An atmosphere control apparatus according to claim 1, wherein the device-manufacturing apparatus is a coater/developer which applies photo-resists onto substrates and develops the resist-coated substrates.

5. An exposure apparatus comprising:
an exposure main body section having an exposure optical system which transfers mask patterns onto substrates; and
a chamber which encloses at least a part of the exposure main body section, wherein
the chamber has separating members which separate a first space and a second space, the first space enclosing a first one of a plurality of elements which form at least a part of the exposure main body section, the second space enclosing a second one of the elements, and
the separating members prevent external atmosphere around the chamber from entering the first space during maintenance of the second one of the elements disposed in the second space performed using apertures formed on the chamber.

6. An exposure apparatus according to claim 5, wherein the first one of the elements disposed in the first space is subjected to maintenance using the apertures formed on the chamber; and by using the separating members.

7. An exposure apparatus according to claim 5, wherein the first one of the elements disposed in the first space is subjected to maintenance using the apertures formed on the chamber; and by using the separating members.

8. An exposure apparatus according to claim 5, wherein the second one of the elements includes at least one of: a temperature regulating mechanism which regulates the temperature of the exposure main body section; and an electric control section which controls the exposure main body section electrically.

9. An exposure apparatus according to claim 5, wherein the separating members are disposed capable of freely opening and closing in the chamber.

10. An exposure apparatus according to claim 5, wherein the separating members are formed from chemically-cleaned sheet members.

11. An exposure apparatus according to claim 5, wherein the first one of the elements includes a transportation mechanism which transports substrates.

12. An exposure apparatus according to claim 5, further comprising atmosphere control apparatuses which regulate an atmosphere in the first space so that air pressure in the first space is greater than air pressure in the second space at least during maintenance of the second one of the elements.

13. An exposure apparatus according to claim 6, further comprising atmosphere control apparatuses which regulate an atmosphere in the first space so that air pressure in the first space is greater than air-pressure in the second space at least during maintenance of the second one of the elements.

14. An exposure apparatus according to claim 7, further comprising atmosphere control apparatuses which regulate an atmosphere in the first space so that air pressure in the first space is greater than air pressure in the second space at least during maintenance of the second one of the elements.

15. An exposure apparatus according to claim 8, further comprising atmosphere control apparatuses which regulate an atmosphere in the first space so that air pressure in the first space is greater than air pressure in the second space at least during maintenance of the second one of the elements.

16. An exposure apparatus according to claim 9, further comprising atmosphere control apparatuses which regulate an atmosphere in the first space so that air pressure in the first space is greater than air pressure in the second space at least during maintenance of the second one of the elements.

17. An exposure apparatus according to claim 10, further comprising atmosphere control apparatuses which regulate an atmosphere in the first space so that air pressure in the first space is greater than air pressure in the second space at least during maintenance of the second one of the elements.

18. An exposure apparatus according to claim 11, further comprising atmosphere control apparatuses which regulate an atmosphere in the first space so that air pressure in the first space is greater than air pressure in the second space at least during maintenance of the second one of the elements.
